(19) United States
(12) Patent Application Publication
(10) Pub. No.: US 2019/0263292 A1
(43) Pub. Date: Aug. 29, 2019

(54) SENSOR DIAGNOSTICS FOR A CAPACITIVE SENSING SYSTEM

(71) Applicant: IEE INTERNATIONAL ELECTRONICS & ENGINEERING S.A., Echternach (LU)

(72) Inventor: Laurent LAMESCH, Reichlange (LU)

(21) Appl. No.: 16/345,409

(22) PCT Filed: Oct. 26, 2017
(86) PCT No.: PCT/EP2017/077396

§ 371 Date: Apr. 26, 2019

(30) Foreign Application Priority Data
Oct. 28, 2016 (LU) 93284

(51) Int. Cl. B60N 2/00; B60R 21/015; B60N 2/56

(52) U.S. Cl. CPC B60N 2/002; B60R 21/0154; B60N 2/5685; B60R 21/01532

(57) ABSTRACT

A capacitive sensor device configured for being connected to at least one electric heating member serving as a capacitive antenna electrode. The capacitive sensor device includes a common mode choke connected between the heating current supply and the electric heating member, a capacitive sensing circuit configured to determine a complex electrical impedance between the electric heating member and a counter electrode, an electric measuring shunt for providing a voltage that is representative of an electric current flowing through the electric heating member, and a remotely controllable source of direct current electrically connected in parallel to the heating current supply. The remotely controllable source of direct current is configured to provide, upon receiving a remote control signal, an electric pulse having a predetermined amount of electric charge to the at least one electric heating member.

### TECHNICAL FIELD

The present invention generally relates to capacitive sensing, e.g. for detecting the presence or absence of a person on a seat (seat occupancy detection) or the presence or absence of a person's hand on the steering wheel of a car (hands-off or hands-on detection).

More specifically, the present invention relates to a capacitive sensor device using a heating member as an antenna electrode, and a seat occupancy detection system for detecting an occupancy status of the seat, in particular a vehicle seat, comprising such capacitive sensor device.

### BACKGROUND OF THE INVENTION

Capacitive sensors and capacitive measurement and/or detection systems employing capacitive sensors have a wide range of applications, and are among others used for the detection of the presence and/or the position of a conductive body in the vicinity of an antenna electrode. As used herein, the term “capacitive sensor” designates a sensor, which generates a signal responsive to the influence of what is being sensed (a person, a part of a person's body, a pet, an object, etc.) upon an electric field. A capacitive sensor generally comprises at least one antenna electrode, to which is applied an oscillating electric signal and which thereupon emits an electric field into a region of space proximate to the antenna electrode, while the sensor is operating. The sensor comprises at least one sensing electrode which may be identical with or different from emitting antenna electrodes at which the influence of an object or living being on the electric field is detected.

Different capacitive sensing mechanisms are for instance explained in the technical paper entitled “Electric Field Sensing for Graphical Interfaces” by J. R. Smith et al., published in IEEE Computer Graphics and Applications, 18(3): 54-60, 1998. The paper describes the concept of electric field sensing as used for making non-contact three-dimensional position measurements, and more particularly for sensing the position of a human hand for purposes of providing three dimensional positional inputs to a computer. Within the general concept of capacitive sensing, the author distinguishes between distinct mechanisms he refers to as “loading mode”, “shunt mode”, and “transmit mode” which correspond to various possible electric current pathways. In the “loading mode”, an oscillating voltage signal is applied to a transmit electrode, which builds up an oscillating electric field to ground. The object to be sensed modifies the capacitance between the transmit electrode and ground. In the “shunt mode”, which is alternatively referred to as “coupling mode”, an oscillating voltage signal is applied to the transmitting electrode, building up an electric field to a receiving electrode, and the displacement current induced at the receiving electrode is measured. The measured displacement current depends on the body being sensed. In the “transmit mode”, the transmit electrode is put in contact with the user's body, which then becomes a transmitter relative to a receiver, either by direct electrical connection or via capacitive coupling.

The capacitive coupling strength may e.g. be determined by applying an alternating voltage signal to an antenna electrode and by measuring the current flowing from that antenna electrode either towards ground (in the loading mode) or into a second antenna electrode (in coupling mode). This current may be measured by a transimpedance amplifier, which is connected to the sensing electrode and which converts the current flowing into the sensing electrode into a voltage proportional to the current.

Capacitive sensors which use a heating member as antenna electrode are known in the patent literature. A capacitive measurement circuit for determining a complex impedance of such capacitive sensor may include a common mode choke. Common mode chokes include at least two wire windings, usually having the same number of turns, wound on a common ferrite core. The at least two wire windings work as simple wires against differential mode current flowing through the common mode choke windings in opposite current directions. Against common mode current flowing through the common mode choke windings in the same current direction, the at least two wire windings work as an inductor having a large impedance. For this reason, the common mode choke (CMC) is often employed to provide for AC-decoupling of the heating member from a heating current supply.

This is illustrated, by way of example, in patent application US 2011/0148648 A1 which describes a capacitive occupant sensing system for a vehicle seat, using a seat heating member 12 as antenna electrode. FIG. 1 schematically shows an illustration of this prior art. Voltage source 2 represents the power supply for the heater, for example a seat heater control unit. Electronic control module (ECM) 1 is configured as a capacitive measurement circuit. It comprises a common mode choke 5, an AC voltage source 9 and capacitors 6, 7 and 8. Capacitor 8 couples the AC voltage generated by AC voltage source 9 into the node 11. The heating member 12 has a complex impedance 13 towards ground. The complex impedance 13 includes a capacitive component as well as a resistive component, which depend on the occupancy state of the vehicle seat. Complex impedance 13 is thus hereinafter also referred to as “unknown impedance” or “impedance to be determined”. The capacitor 8 forms together with the unknown impedance 13 a voltage divider. The complex voltage Uₘₑₐₛ between node 11 and circuit ground 10 can be used to calculate the unknown complex impedance 13. The common mode choke 5 decouples the AC voltage on node 11 from AC ground due to its large impedance. The heating member 12 may at the same time be traversed by the DC current supplied by voltage source 2 and driven with the AC voltage by the capacitive measurement circuit. Capacitors 6 and 7 ensure that a defined AC ground is present on the side of the common mode choke 5 that is connected to the DC power supply of the seat heater. Ground 3 is the reference ground. The connections of the common mode coke 5 are numbered 5.1 through 5.4: connection 5.1 connects the first winding to the high potential side of the voltage source 2; connection 5.2 connects the first winding to the high potential side of the heating member 12; connection 5.3 connects the second winding to the low potential side of the heating member 12 and connection 5.4 connects the second winding to the low potential side of the voltage source 2. Resistor 4 represents the wiring resistance of the wiring between the low potential side of voltage source 2 and the fourth connection 5.4 of common mode choke 5.

The present invention is related to a capacitive sensor device using an electric heating member as a capacitive antenna electrode and comprising a common mode choke that is provided to interconnect the electric heating member and a heating current supply.

The electric heating member may in particular form part of a seat, for example a vehicle seat, or of a vehicle steering wheel.

For capacitive sensor devices that use an electric heating member as a capacitive antenna electrode it is essential to check the electric heating member for potential interruption. If the electric heating member was interrupted, it would no longer correctly fulfil its function as capacitive antenna electrode.

If one or more additional heater(s), for example a back rest heater, is or are connected in parallel to the heater ECU, a simple solution which injects a DC current into the heaters and measures the voltage drop across the heaters is not possible because the paralleled back rest heater will hide a seat heater interruption. Also other conventional methods for performing a functional test of the electric heating member cannot be applied. For instance, an injection of an electric current of the usual high measurement frequencies through the electric heating member via the common mode choke is not feasible due to the required guarding. Another conventional method, which is to control the heating current supply to provide a heating current pulse, is not a viable option as the heating current supply (or a control unit that is provided to control the heating current supply) may be in a low-voltage or fault mode, or a communication to the control unit may not be available at all times.

### SUMMARY

It is therefore an object of the invention to provide a capacitive sensor device that is capable of autonomously performing a diagnosis of an electric heating member serving as a capacitive antenna electrode.

In one aspect of the present invention, the object is achieved by a capacitive sensor device that is configured for being connected to at least one electric heating member and for being connected to a heating current supply for providing electric power to the at least one electric heating member. The at least one electric heating member is configured for serving as a capacitive antenna electrode.

The phrase “configured to”, as used in this application, shall in particular be understood as being specifically programmed, laid out, furnished or arranged.

The capacitive sensor device comprises a common mode choke, a capacitive sensing circuit, an electric measuring shunt and a remotely controllable source of direct current.

The common mode choke has first and second inductively coupled windings. The first winding is configured to be connected between a first terminal of the heating current supply and a first terminal of the electric heating member. The second winding is configured to be connected between a second terminal of the electric heating member and a second terminal of the heating current supply.

The capacitive sensing circuit is configured to inject a periodic measurement signal into the at least one electric heating member via a measurement node and to measure, in response to the injected measurement signal, an electric quantity at the measurement node that is usable to determine a complex electrical impedance between the at least one electric heating member and a counter electrode.

The electric measuring shunt is electrically connected in series to the at least one electric heating member for providing a voltage that is representative of an electric current flowing through the at least one electric heating member.

The remotely controllable source of direct current is electrically connectable in parallel to the heating current supply. The remotely controllable source of direct current is configured to provide, upon receiving a remote control signal, an electric pulse having a predetermined amount of electric charge to the at least one electric heating member.

As a differential mode current, the electric pulse is conducted by the common mode choke in an unaffected manner. The electric measuring shunt serves as a current monitor. The capacitive sensing device allows, at almost any time of its operation, for assessing the functional integrity of the at least one electric heating member based on a voltage provided by the electric measuring shunt in response to the electric pulse and by comparing the voltage at the electric measuring shunt, or an electric quantity derived from the voltage, with at least one predetermined criterion. For instance, one criterion may be that a predetermined minimum level of electric current has to be detected to assess the electric heating member as being faultless.

The invention is particularly applicable with benefits for at least one electric heating member of a seat, in particular a vehicle seat, but is also contemplated to apply the invention for other purposes, such as an electric heating member of the steering wheel.

The term “vehicle”, as used in this application, shall particularly be understood to encompass passenger cars, trucks and buses. It is further noted herewith that the terms “first”, “second”, etc. are used in this application for distinction purposes only, and are not meant to indicate or anticipate a sequence or a priority in any way.

The periodic measurement signal may in particular be alternating measurement signal.

Preferably, the capacitive sensing circuit is configured to determine a complex electrical impedance between the at least one electric heating member and a counter electrode that is formed by ground potential; i.e. the at least one electric heating member serving as a capacitive antenna electrode is operated in loading mode. Capacitive sensing circuits of this kind are known in the art and therefore need not be described in more detail herein.

In at least some embodiments of the invention, the remotely controllable source of direct current includes a capacitor that is configured to provide the predetermined amount of electric charge during a transition between two different states of charge of the capacitor. In particular, the provided predetermined amount of the electric charge is the product of a capacitance of the capacitor and a voltage difference of the two different states of charge of the capacitor. In this manner, a source of direct current can be provided that requires few parts and is therefore particularly cost-efficient. The charged capacitor can advantageously generate a high current pulse without drawing significant peak current from the power supply.

In some embodiments of the capacitive sensor device, the remotely controllable source of direct current further includes a current supply that is configured to provide the predetermined amount of electric charge uniformly during a predetermined pulse duration. In particular, the provided predetermined electric charge is the product of a magnitude of the electric current and the pulse duration. By that, it can be enabled to evaluate the voltage that is representative of an electric current flowing through the at least one electric heating member at almost any time during the electric pulse, by which requirements regarding evaluating the voltage can be relaxed.

In some embodiments of the capacitive sensor device, one of the inductively coupled windings of the common mode choke serves as the electric measuring shunt. In this way, the extra hardware effort for the electric measuring shunt can be saved. Moreover, a power dissipation occurring at the extra electric measuring shunt can be eliminated.

In some embodiments the invention also provides a capacitive measurement system that comprises a capacitive sensor device as disclosed herein and a microcontroller that is configured for remotely controlling the remotely controllable source of direct current. The benefits described in context with the capacitive sensor device apply to such capacitive measurement system to the full extent.

Preferably, the microcontroller includes a processor unit, a digital data memory unit, a microcontroller system clock and at least one control output, for instance formed by a plurality of pulse width modulation units, for remotely controlling the remotely controllable source of direct current. Such equipped microcontrollers are commercially available in many variations and at economic prices. In this way, an automated measurement procedure employing the capacitive sensor device disclosed herein can be enabled.

An especially simple and cost-effective solution for the capacitive measurement system can be accomplished if the microcontroller further includes at least one analog-to-digital converter having an input port that is electrically connected to the electric measuring shunt for determining the voltage across the electric measuring shunt. By that, a fast and undisturbed digital signal processing can be facilitated.

In some embodiments the invention provides all the described benefits by a seat occupancy detection system for detecting an occupancy of a seat, in particular a vehicle seat. The seat occupancy detection system comprises the disclosed capacitive measurement system, at least one electric heating member that is arranged at a cushion or a backrest forming part of the seat and that is employable as the capacitive antenna electrode, and a heating current supply for providing electric power to the at least one electric heating member.

In another aspect of the invention, a method of operating the disclosed capacitive measurement system with regard to a functional test of the at least one electric heating member is provided. The method comprises steps of
a) sending a remote control signal to the remotely controllable source of direct current to enable provision of an electric pulse having a predetermined amount of electric charge at least to the at least one electric heating member,
b) determining the voltage across the electric measuring shunt, and
c) comparing an electric quantity that is derivable from the determined voltage with a predetermined threshold for the electric quantity.

If the electric quantity is lower than the predetermined threshold for the electric quantity, in a step (d) a signal is generated that is indicative of the at least one electric heating member to be defective. In this manner, the function of the at least one electric heating member can be tested at almost all times of operation of the capacitive sensor device within the capacitive measurement system.

In some embodiments, the electric quantity can be equal to the determined voltage. In other embodiments, the electric quantity can for instance be the time integral of the determined voltage over at least a portion of a duration of the electric pulse. This time integral is proportional to the electric charge that flowed through the at least one electric heating member in the portion of the duration of the electric pulse. Other electric quantities that are derivable from the determined voltage are also contemplated for use.

In some embodiments, the method comprises a preceding step of determining an output voltage of the heating current supply. The determined output voltage of the heating current supply provides the information whether the at least one heating member is provided with electric power by the heating current supply or not.

If the determined output voltage fulfills the conditions of being smaller than or equal to a predetermined lower threshold that is close to zero, the at least one heating member is not provided with electric power from the heating current supply. In this case, the steps (a) to (d) of the method disclosed above are carried out without modification.

If the determined output voltage fulfills the conditions of being larger than the predetermined lower threshold that is close to zero, the at least one heating member is being provided with electric power from the heating current supply. In this case, there is already heating current flowing and the voltage drop across the electric measuring shunt caused by the heating current may be used to check the integrity of the heater. In a possible embodiment, the steps (a) to (d) of the method disclosed above are also carried out when the at least one heating member is powered by the heating current supply with the modification that the predetermined threshold for the electric quantity is replaced by a second predetermined threshold for the electric quantity, which is distinct from the predetermined threshold. The second predetermined threshold considers the superposition of the electric power provided by the heating current supply and the electric pulse of the remotely controllable source of direct current. The contribution of a heating current provided by the heating current supply is accounted for by this measure.

In this way, a functional test of the at least one electric heating member can be carried out irrespective of an operational status of the heating current supply. It should however be noted that as the current measurement in this case has to measure the superposition of heating current and current pulse, and as the current pulse is small compared to the heating current, the relative accuracy requirement for the current measurement is higher than if this case is not considered.

Some embodiments of the method further comprise an additional step of redetermining an output voltage of the heating current supply that is to be carried out after executing the above-mentioned steps of determining an output voltage of the heating current supply and steps (a) to (c). Step (d) is executed upon a fulfilled condition that the redetermined output voltage is equal within a predetermined margin of tolerance to the output voltage of the heating current supply determined in the preceding step. If the condition is not fulfilled, execution of the method may be resumed by carrying out step (a). By implementing this condition it can be ensured that the proper predetermined threshold for the electric quantity is used for comparing the electric quantity in step (c).

Some embodiments of the method further include a preceding step of determining the voltage across the electric measuring shunt. After execution of the preceding step, steps (a) and (b) are carried out as disclosed. In an additional step of the method, a difference between the voltage across the electric measuring shunt as determined in step (b) and the voltage across the electric measuring shunt as determined in the preceding step is calculated. By this, a potential offset voltage can be eliminated. Then, the calculated difference is used as the electric quantity for executing step (c) and conditional step (d) of the method.

In preferred embodiments, the steps of the method are automatically and periodically carried out. Preferably, the steps are carried out by the microcontroller of the capacitive measurement system.

It will be readily appreciated by those skilled in the art that the disclosed method does not exclude or hinder the option to functionally test the at least one electric heating member in a conventional way by executing steps (b) to (d) of the method if the determined output voltage of the heating current supply is larger than the predetermined lower threshold that is close to zero.

In yet another aspect of the invention, a non-transitory computer-readable medium is used to provide a software module for controlling an execution of the method disclosed herein.

The method steps to be conducted are converted into a program code of the software module. The program code is implementable in a digital data memory unit of the seat occupancy detection system; that is, it is stored on the computer-readable medium and is executable by a processor unit of the seat occupancy detection system. Preferably, the digital data memory unit and/or the processor unit may be a digital data memory unit and/or a processing unit of the capacitive measurement system. The processor unit may, alternatively or supplementary, be another processor unit that is especially assigned to execute at least some of the method steps.

The software module can enable a robust and reliable execution of the method and can allow for a fast modification of method steps.

### BRIEF DESCRIPTION OF THE DRAWINGS

Further details and advantages of the present invention will be apparent from the following detailed description of not limiting embodiments with reference to the attached drawing, wherein:

FIG. 1 is a layout of a conventional seat occupancy detection system,

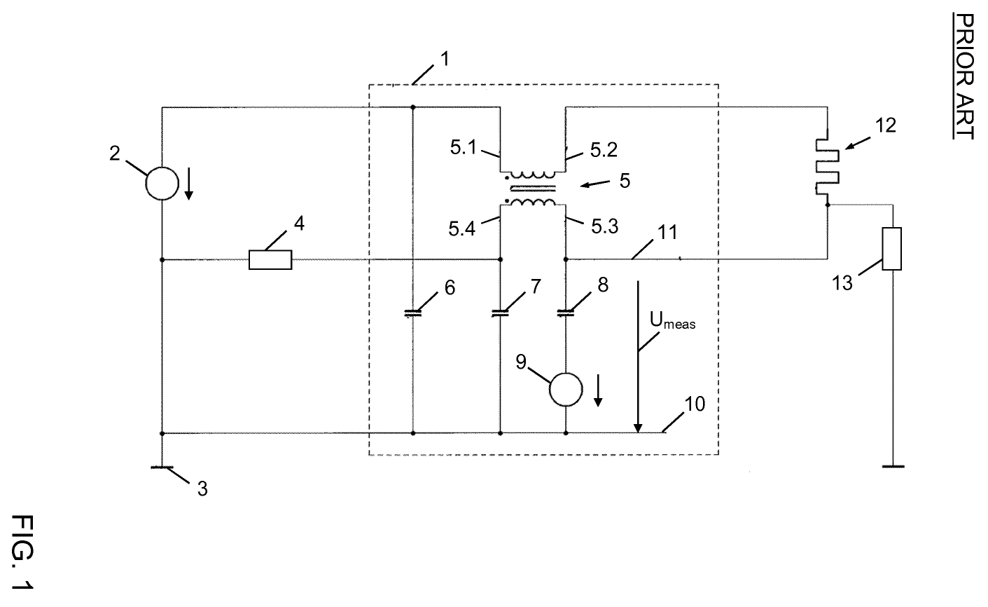

FIG. 2 shows a layout of an embodiment of a seat occupancy detection system comprising a capacitive sensor device in accordance with the invention,

FIG. 3 is a flowchart of an embodiment of a method in accordance with the invention, and

FIG. 4 is a flowchart of another embodiment of a method in accordance with the invention.

### DESCRIPTION OF THE ILLUSTRATED EMBODIMENTS

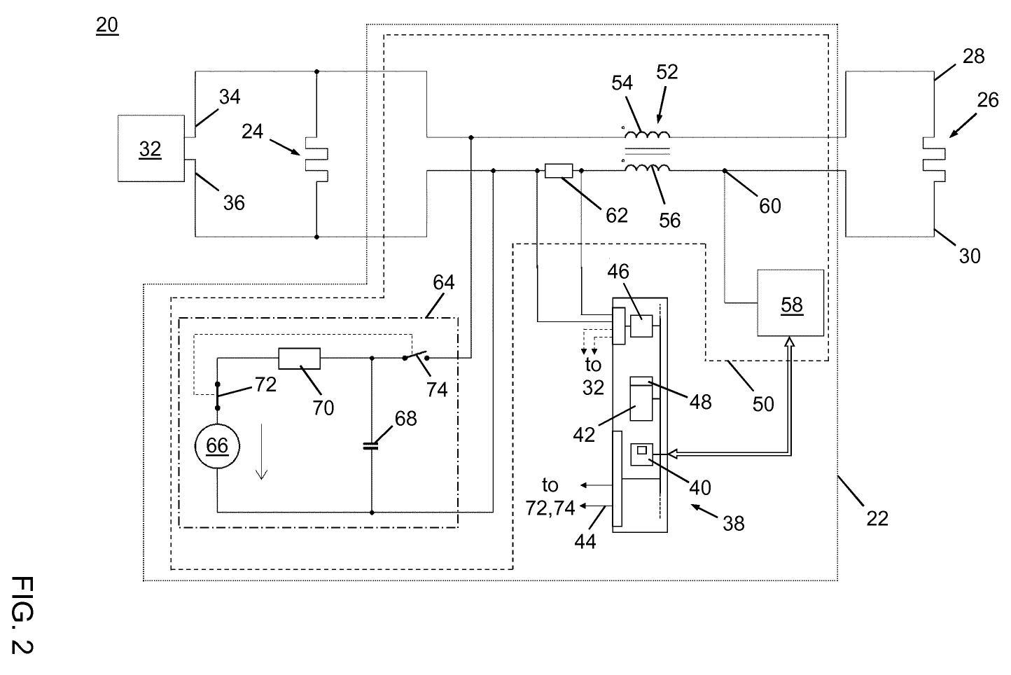

FIG. 2 illustrates a layout of an embodiment of a seat occupancy detection system 20 comprising a capacitive measurement system 22 with a capacitive sensor device 50 in accordance with the invention.

The seat occupancy detection system 20 is configured to detect an occupancy of a seat, in particular a vehicle seat of a passenger car, and includes the capacitive measurement system 22, a first electric heating member 24 that is arranged at a backrest of the vehicle seat and a second electric heating member 26 that is arranged at a seat cushion forming part of the vehicle seat. The second electric heating member 26 is employed as a capacitive antenna electrode. Moreover, the seat occupancy detection system 20 comprises a heating current supply 32 designed as an electronic control unit for providing electric power to the electric heating members 24, 26. In an operational state, the heating current supply 32 is configured to switch the electric power that is provided between a first output terminal 34 and a second output terminal 36 periodically on and off to control an electric heating power that is supplied to the seat heating members 24, 26 according to a pulse-width modulation scheme. A typical switching frequency may, for example, be 25 Hz.

The capacitive sensor device 50 is electrically connected to the electric heating members 24, 26 and to the heating current supply 32. The second electric heating member 26 serves as a capacitive antenna electrode for the capacitive sensor device 50. The capacitive sensor device 50 includes a common mode choke 52 with first and second inductively coupled windings 54, 56. The first winding 54 is electrically connected between the first output terminal 34 of the heating current supply 32 and a first terminal 28 of the second electric heating member 26. The second winding 56 is electrically connected between a second terminal 30 of the second electric heating member 26 and the second output terminal 36 of the heating current supply 32. The first electric heating member 24 is electrically connected directly to the first output terminal 34 and the second output terminal 36 of the heating current supply 32.

The capacitive sensor device 50 further includes a capacitive sensing circuit 58 that is configured to inject a periodic alternating measurement signal into the second electric heating member 26 via a measurement node 60. The measurement node 60 is arranged at the electrical connection between the second winding 56 of the common mode choke 52 and the second terminal 30 of the second electric heating member 26. The capacitive sensing circuit 58 is configured to measure, in response to the injected measurement signal and using this a reference voltage, a complex electric voltage at the measurement node 60. From the measured complex electric voltage, the capacitive sensing circuit 58 is configured to determine a complex electrical impedance between the second electric heating member 26 and the vehicle chassis, which forms a counter electrode at ground potential. In this way, the second electric heating member 26 and the capacitive sensing circuit 58 are configured for operating in loading mode.

By the described arrangement, the common mode choke 52 AC-decouples the capacitive sensing circuit 58 from the first electric heating member 24 and the heating current supply 32.

Moreover, the capacitive sensor device 50 comprises an electric measuring shunt 62 that is electrically connected in series to the second electric heating member 26 for providing a voltage that is representative of an electric current flowing through the second electric heating member 26. The electric measuring shunt 62 is arranged between the second winding 56 of the common mode choke 52 and the second output terminal 36 of the heating current supply 32.

A remotely controllable source of direct current (DC) 64 forms part of the capacitive sensor device 50. The DC source 64 is electrically connected in parallel to the first output terminal 34 and the second output terminal 36 of the heating current supply 32. The remotely controllable DC source 64 includes a DC voltage source 66, a capacitor 68, a resistor 70 and two coupled, remotely controllable switches 72, 74 whose switching statuses are persistently opposite to each other. When the first switch 72 is closed (and the second switch 74 is open), the capacitor 68 is charged by the DC voltage source 66 via the resistor 70. When the first switch 72 is open (and the second switch 74 is closed), the capacitor 68 supplies a current pulse that flows through the first winding 54 of the common mode choke 52, the second electrical heating member 26, the second winding 56 of the common mode choke 52 and the electric measuring shunt 62. For the sake of completeness it is noted that the capacitor 68 also supplies a portion of the pulse current to the first electrical heating member 24, but this fact is not relevant for the further considerations. Thus, upon receiving a remote control signal for a selected duration of the current pulse, the remotely controllable DC source 64 is configured to provide the electric current pulse having a predetermined amount of electric charge to the electric heating members 24, 26. The amount of flowing electric charge is given by the product of the capacitance of the capacitor 68 and the voltage difference of the capacitor 68 at the start and at the end of the current pulse, i.e. during a transition between two different states of charge of the capacitor 68.

The capacitive measurement system 22 further comprises a microcontroller 38. The microcontroller 38 includes a processor unit 40, a digital data memory unit 42 to which the processor unit 40 has data access, and a microcontroller system clock that forms part of the processor unit 40. The digital data memory unit 42 comprises a non-transitory computer-readable medium. The microcontroller 38 is configured for remotely controlling the remotely controllable DC source 64. To this end, the microcontroller 38 is equipped with control outputs 44 formed as a plurality of pulse width modulation (PWM) units that are able to provide mutually independent PWM signals.

Moreover, the microcontroller 38 includes a plurality of analog-to-digital converters (ADCs) 46. Input lines of two ADCs 46 are electrically connected to ends of the electric measuring shunt 62 for determining the voltage across the electric measuring shunt 62 in a differential amplifier configuration. Other ADCs are also electrically connected (not shown) to the first output terminal 34 and the second output terminal 36 of the heating current supply 32 for determining an output voltage of the heating current supply 32.

A control link (indicated by a double arrow in FIG. 2) between the microcontroller 38 and the capacitive sensing circuit 58 enables data transfer and control.

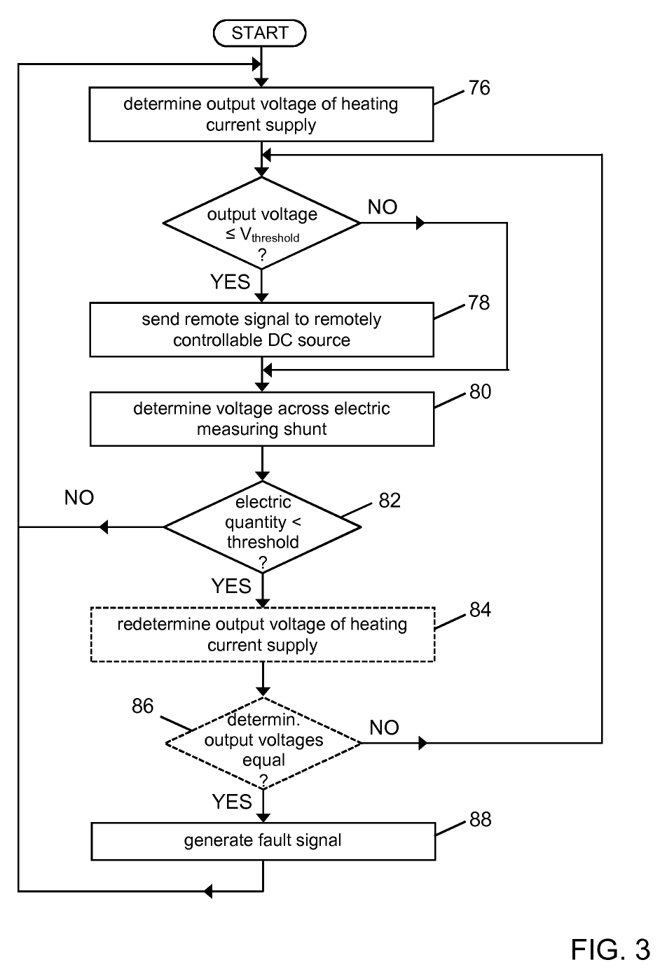

In the following, an embodiment of a method of operating the seat occupancy detection system 20 pursuant to FIG. 2 with regard to a functional test of the second electric heating member 26 will be described. A flowchart of the method is provided in FIG. 3. In preparation of operating the seat occupancy detection system 20, it shall be understood that all involved units and devices are in an operational state and configured as illustrated in FIG. 2.

In order to be able to carry out the method automatically and periodically and in a controlled way, the microcontroller 38 comprises a software module 48 (FIG. 2). The method steps to be conducted are converted into a program code of the software module 48. The program code is implemented in the digital data memory unit 42 of the microcontroller 38 and is executable by the processor unit 40 of the microcontroller 38.

Referring now to FIG. 3, in a first step 76 of the method, an output voltage of the heating current supply 32 is determined by the ADCs 46 of the microcontroller 38. After that, a bifurcation in the flowchart occurs.

If the determined output voltage of the heating current supply 32 is smaller than or equal to a predetermined lower threshold that is close to zero, namely 1.0 V, i.e. if the heating members 24, 26 are not powered by the heating current supply 32, the microcontroller 38 sends, in the following step 78, a remote control signal to the remotely controllable DC source 64 to enable provision of an electric pulse having a predetermined amount of electric charge to the electric heating members 24, 26. All predetermined threshold and tolerance values mentioned herein reside in the digital data memory unit 42 of the microcontroller 38 and can readily be retrieved by the processor unit 40.

In a next step 80, the voltage across the electric measuring shunt 62 is determined by the microcontroller 38 via the ADCs 46 in a periodic manner such that a plurality of voltage measurements is carried out during the duration of the electric pulse, and a time integral of the determined voltage is calculated as an electric quantity derived from the determined voltage by the processor unit 40. Then, in the next step 82, the electric quantity is compared with a predetermined threshold for the electric quantity. As an optional step 84 of the method (optional steps are indicated in the flowchart of FIG. 3 by dashed lines), an output voltage of the heating current supply 32 is redetermined and then compared to the previous determined output voltage in another step 86. If the redetermined output voltage is equal to the previous determined output voltage within a predetermined margin of tolerance of ±20%, the next step is carried out. If not, the method is restarted with the step 78 of sending a remote control signal to the remotely controllable DC source 64. If the derived electric quantity is lower than the predetermined threshold for the electric quantity, a fault signal that is indicative of the second electric heating member 26 to be defective is generated by the microcontroller 38 as the next step 88. If the derived electric quantity is equal to or larger than the predetermined threshold for the electric quantity, the method steps are started all over again.

If the output voltage of the heating current supply 32 determined in step 76 is larger than the predetermined lower threshold, i.e. if the heating members 24, 26 are powered by the heating current supply 32, there is already heating current flowing and the voltage drop across the electric measuring shunt 62 caused by the heating current may be used to check the integrity of the heater. It follows that there is no need to switch on the DC source 64 to feed the heater and the integrity test of the heating member 26 may be achieved in a conventional way by directly executing steps 80, 82 and 88.

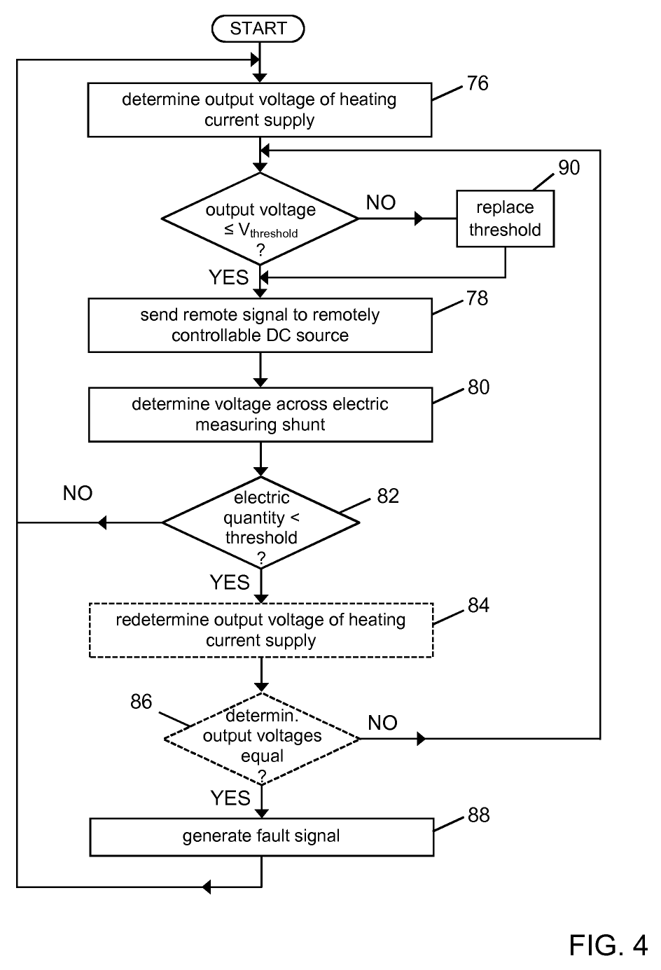

In the embodiment of the method as shown in FIG. 4, the integrity check of the heater member 26 uses the DC source also in the case, in which the output voltage of the heating current supply 32 determined in step 76 is larger than the predetermined lower threshold, i.e. if the heating members 24, 26 are powered by the heating current supply 32. In this case, it is preferable to consider the superposition of the electric power provided by the heating current supply and the electric pulse of the remotely controllable source of direct current. In this embodiment, the microcontroller 38 replaces in another step 90 the predetermined threshold for the electric quantity by a second predetermined threshold that is distinct from the predetermined threshold and retrieved from the digital data memory unit 42. Then, the method steps are executed, starting with step 78 and using the second predetermined threshold for the electric quantity.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. A capacitive sensor device that is configured to be connected to at least one electric heating member and to a heating current supply for providing electric power to the at least one electric heating member, wherein the at least one electric heating member is configured to serve as a capacitive antenna electrode, the capacitive sensor device comprising:
a common mode choke having first and second inductively coupled windings, wherein the first winding is configured to be connected between a first output terminal of the heating current supply and a first terminal of the electric heating member, and wherein the second winding is configured to be connected between a second terminal of the electric heating member and a second output terminal of the heating current supply,
a capacitive sensing circuit that is configured to inject a periodic measurement signal into the at least one electric heating member via a measurement node and to measure, in response to the injected measurement signal, an electrical quantity at the measurement node that is usable to determine a complex electrical impedance between the at least one electric heating member and a counter electrode,
an electric measuring shunt that is electrically connected in series to the at least one electric heating member for providing a voltage that is representative of an electric current flowing through the at least one electric heating member, and
a remotely controllable source of direct current that is electrically connectable in parallel to the heating current supply,
wherein the remotely controllable source of direct current includes a capacitor that is configured to provide, upon receiving a remote control signal, an electric pulse having a predetermined amount of electric charge to the at least one electric heating member during a transition between two different states of charge of the capacitor.

2. The capacitive sensor device as claimed in claim 1, wherein the remotely controllable source of direct current further includes a current supply that is configured to provide the predetermined amount of electric charge uniformly during a predetermined pulse duration.

3. The capacitive sensor device as claimed in claim 1, wherein one of the inductively coupled windings of the common mode choke serves as the electric measuring shunt.

4. A capacitive measurement system including:
a capacitive sensor device as claimed in claim 1, and
a microcontroller that is configured for remotely controlling the remotely controllable source of direct current.

5. The capacitive measurement system as claimed in claim 4, wherein the microcontroller includes at least one analog-to-digital converter having an input port that is electrically connected to the electric measuring shunt for determining the voltage across the electric measuring shunt.

6. A seat occupancy detection system for detecting an occupancy of a seat, in particular a vehicle seat, the seat occupancy detection system comprising:
a capacitive measurement system as claimed in claim 4,
at least one electric heating member that is arranged at a cushion or a backrest forming part of the seat and that is employable as the capacitive antenna electrode, and
a heating current supply for providing electric power to the at least one electric heating member.

7. A method of operating the capacitive measurement system as claimed in claim 4 with regard to a functional test of the at least one electric heating member, the method comprising steps of:
(a) sending a remote control signal to the remotely controllable source of direct current to enable provision of an electric pulse having a predetermined amount of electric charge at least to the at least one electric heating member,
(b) determining the voltage across the electric measuring shunt,
(c) comparing an electric quantity that is derivable from the determined voltage with a predetermined threshold for the electric quantity, and
(d) if the electric quantity is lower than the predetermined threshold for the electric quantity, generate a signal that is indicative of the at least one electric heating member to be defective.

8. The method as claimed in claim 7, comprising preceding steps of:
(e) determining an output voltage of the heating current supply, and
(f) carrying out the steps (a) through (d) upon a fulfilled condition that the determined output voltage is smaller than or equal to a predetermined lower threshold that is close to zero, or
(g) carrying out the steps (a) through (d) using a second predetermined threshold for the electric quantity that is distinct from the predetermined threshold upon a fulfilled condition that the determined output voltage is larger than the predetermined lower threshold that is close to zero.

9. The method as claimed in claim 8, further comprising steps of:
after executing step (e) and steps (a) through (c), redetermining an output voltage of the heating current supply, and
executing step (d) upon a fulfilled condition that the redetermined output voltage is equal to the output voltage determined in step (e) within a predetermined margin of tolerance.

10. The method as claimed in claim 9, comprising preceding steps of:
determining the voltage across the electric measuring shunt,
carrying out the steps (a) and (b),
calculating a difference between the voltage across the electric measuring shunt as determined in step (b) and the voltage across the electric measuring shunt as determined in the first step of this claim, and
using the calculated difference as the electric quantity while executing steps (c) and (d).

11. The method as claimed in claim 7, wherein the steps are automatically and periodically carried out.

12. A non-transitory computer-readable medium for controlling an execution of the method as claimed in claim 7, wherein the method steps are stored on the computer-readable medium as a program code, wherein the computer-readable medium comprises a part of the capacitive measurement system or a separate control unit and the program code is executable by a processor unit of the capacitive measurement system or a separate control unit.
